(19) United States
(12) Patent Application Publication
(10) Pub. No.: US 2017/0311392 A1
(43) Pub. Date: Oct. 26, 2017

(54) SYSTEM FOR GENERATING HEAT BY MEANS OF MAGNETIC INDUCTION

(71) Applicant: MAXWELL & LORENTZ, S.L., Madrid (ES)

(72) Inventor: Manuel MARTINEZ RUIZ, Egues Navarra (ES)

(73) Assignee: MAXWELL & LORENTZ, S.L., Madrid (ES)

(21) Appl. No.: 15/517,390

(22) PCT Filed: Oct. 5, 2015
(86) PCT No.: PCT/ES2015/070724

§ 371 Date: Apr. 6, 2017

(30) Foreign Application Priority Data
Oct. 7, 2014 (ES) P201431476

(51) Int. Cl. H05B 6/10

(52) U.S. Cl. CPC H05B 6/101; H05B 2206/02

(57) ABSTRACT

The present invention relates to a system for generating heat by magnetic induction, formed by two or more discs which are arranged consecutively close to one another on one and the same plane facing an electrically conductive element to be heated, with a rotating drive rotating the consecutively adjacent discs in opposite directions of rotation, each disc incorporating a distribution of magnets, such that upon rotating the discs, the magnets thereof produce a magnetic influence generating heat in the element to be heated and a force for driving the rotation between the discs.

### FIELD OF THE ART

The present invention relates to heat generation for heating applications, proposing a system which allows producing heat by means of magnetic induction under profitable conditions for heating fluids or similar applications.

### STATE OF THE ART

It is known that when an electrically conductive element is arranged in the scope of the magnetic field of a moving magnet, the influence of the variable magnetic field acting on said element generates heat in said element, heating it up.

Based on that phenomenon, solutions aimed at heating fluids circulating through a copper tube or another electrically conductive tube have been developed, a disc bearing magnets and associated with a rotating drive motor being arranged in relation to the tube.

Solutions of this type are described, for example, in the Spanish utility model ES 1077579U and in patent documents U.S. Pat. No. 2,549,362, US 20090223948, U.S. Pat. No. 5,012,060, U.S. Pat. No. 7,339,144, U.S. Pat. No. 8,408,378 and US 20110272399, all of them based on approaches using a support bearing magnets rotationally operated by a motor to create by means of the moving magnets a variable magnetic field in relation to a metallic tube for the circulation of a fluid to be heated. Practical implementations of said solutions were, however, unsuccessful due to the low heat production performance they offer in relation to the energy consumption needed for rotating the support bearing the magnets.

### OBJECT OF THE INVENTION

The present invention proposes a system for generating heat by means of magnetic induction, based on the movement of magnets, whereby an efficiency improving the performance of the solutions known in that sense and, accordingly, the application features is achieved.

This system object of the invention comprises two or more discs bearing the magnets, arranged consecutively close to one another on one and the same plane, the discs being linked to a drive rotating the consecutive discs in opposite directions.

On the bearing discs, the magnets incorporated therein are distributed circularly close to the periphery of the discs, such that upon rotating the consecutive discs, a magnetic influence is produced between the magnets thereof which causes each of the discs to tend to rotate the consecutively adjacent disc in the opposite direction.

Therefore, by applying the drive on the discs such that it rotates the consecutively adjacent discs in opposite directions, the force for driving the rotation of the discs as a result of the magnetic influence between the magnets thereof is added to the force of the drive, so the force of the drive for rotating the discs at specific revolutions is reduced in the proportion affecting the action of the magnetic influence between the discs, therefore resulting in a lower power consumption requirement.

Under those conditions, if an electrically conductive element, such as for example, a copper coil or the like through which a fluid circulates, is arranged facing the consecutive discs bearing the magnets, said element is heated up by the influence of the variable magnetic field of the magnets of the rotating discs, under conditions improving the heating performance which is obtained in relation to the power consumption of the drive of the discs. To that end, the drive of the discs bearing the magnets can be actuated by means of independent motors or by means of a common drive motor linked to the discs by means of appropriate transmissions, without this altering the object of the invention. The rotating drive rotating the discs (2) can be established using at least one electric motor or using at least one pneumatic turbine.

The number of magnets incorporated in each rotating disc can vary, said number of magnets being associated with the rotational speed of the discs for producing a specific amount of heat through magnetic influence on an electrically conductive element located facing the discs, such that the rotational speed of the discs can be lower with a higher number of magnets in the discs, which reduces the power consumption of the drive, establishing a suitable combination between magnet distribution in the discs and their rotational speed therefore being important for optimizing system performance.

On the other hand, the distance between the element to be heated and the magnets incorporated in the rotating discs are an important factor for efficiency in heat production through magnetic influence on an electrically conductive element located facing the rotating discs bearing the magnets; it has been confirmed in experiments that the highest effectiveness is obtained with a distance between 2 millimeters and 4.5 millimeters, since with greater distance the performance is reduced to unprofitable values, whereas with distances smaller than those indicated the performance is kept practically constant without improvement, adjustment of the assembly being more difficult.

The system can additionally comprise a Peltier cell for generating electrical energy from the heat generated by the element to be heated once the element has been heated. Alternatively, the system can additionally comprise a heat exchanger for producing cold from the heat generated by the element to be heated once the element has been heated.

An electrically conductive block can furthermore be arranged on the element to be heated, in relation to which the optimum distance of the magnets incorporated in the rotating discs is established, with this arrangement the heat generated as a result of the magnetic influence of the magnets incorporated in the rotating discs accumulates in said block arranged on the element to be heated, from which the heat is transmitted more efficiently to the element to be heated, such that the functional performance is improved. It is envisaged that said block arranged on the element to be heated has a grooved surface facing the rotating discs bearing the magnets, whereby it also improves the generation of heat produced as a result of the magnetic influence.

In order to reduce the force necessary for rotating the discs, it has been envisaged that each disc arranged facing the element to be heated incorporates in its lower part an additional disc comprising a set of magnets, the set of magnets being arranged on the outer side contour of the additional disc.

As a result, the system of the invention has features making it efficient and profitable for its intended heating function, acquiring its own identity and preferred character with respect to the known systems that have been developed for the same function.

### DESCRIPTION OF THE DRAWINGS

FIG. 1 shows a diagram of the system object of the invention according to one embodiment in relation to a coil for the circulation of a fluid.

FIG. 2 shows a front view of two adjacent discs bearing the magnets located according to the arrangement of the system of the invention.

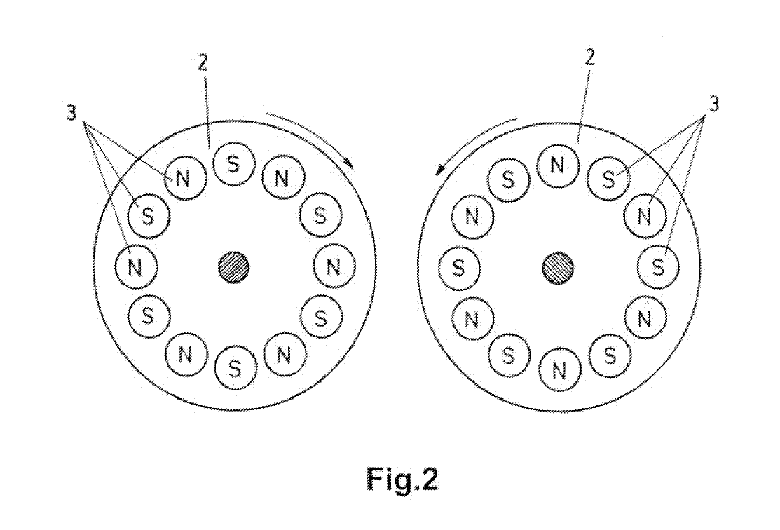

FIG. 3 shows a diagram of an example of the system of the invention in relation to a coil on which there is arranged a block accumulating heat generated as a result of magnetic influence.

FIG. 4 shows a diagram of another example of the system of the invention in which an additional disc, provided with a set of magnets on its outer side contour, is coupled to each of the adjacent discs bearing the magnets.

### DETAILED DESCRIPTION OF THE INVENTION

The object of the invention relates to a system for generating heat by means of magnetic induction on an electrically conductive element (1) for use in applications such as heating a fluid circulating through a copper coil or another electrically conductive coil, which in such case is the element (1) to be heated, without this application being limiting.

The proposed system consists of the arrangement of two or more discs (2) located consecutively close to one another on one and the same plane, each disc (2) having incorporated therein a distribution of magnets (3) and establishing in relation to said discs (2) a rotating drive for driving the consecutively adjacent discs (2) in opposite directions of rotation.

Therefore, by arranging that functional assembly facing an electrically conductive element (1), such as a copper coil or the like through which a fluid circulates, upon rotating the discs (2), the movement of the magnets (3) causes a variable magnetic field to be produced on the element (1) with each of the magnets (3), whereby generating heat heating up said element (1).

In those conditions, the rotational operation of the discs (2) also causes each of them to produce by means of its magnets (3) a magnetic influence on each consecutively adjacent disc (2), which tend to rotate it in the opposite direction, such that between the consecutively adjacent discs (2) there is reciprocally established, as a result of the magnetic influence between them, a rotational force that is added to the force of the rotating drive, so in order to obtain a specific rotational speed a lower force of the drive and, accordingly, a lower power consumption, is required.

Therefore, given that the generation of heat which is produced on the element (1) to be heated depends on the number of magnetic field changes on said element (1), which in turn depends on the number of magnets (3) incorporated in the discs (2) and on the rotational speed thereof, since a lower force of the drive is required for producing a rotational speed of the discs (2), the power consumption required for producing a certain heating of the element (1) to be heated is also lower, entailing an increase in functional performance.

In that sense, it has been confirmed by means of experimental tests that with discs (2) which are each provided with twelve magnets (3) in a circular distribution close to the periphery of the discs (2), a profitable functional performance for practical heating applications is obtained, with rotational speed of the discs (2) between 2800 rpm and 5000 rpm, since with rotational speeds below that range the functional performance is very low, whereas above that range the heat energy which is produced in the element (1) to be heated is virtually constant, such that by increasing the speed above 5000 rpm, the power consumption of the drive is greater to obtain virtually the same amount of heat, so the performance is reduced.

The effectiveness of the generation of heat on the element (1) to be heated also depends on the distance between said element (1) to be heated and the magnets that are incorporated in the discs (2); it has been confirmed in experiments that the best performance is obtained with a distance between 2 mm and 4.5 mm, because if the distance is greater than that range the magnetic induction on the element (1) to be heated is very small and the performance is not acceptable, whereas if the distance is smaller than that range, it virtually does not improve the production of heat by means of magnetic induction on the element (1) to be heated.

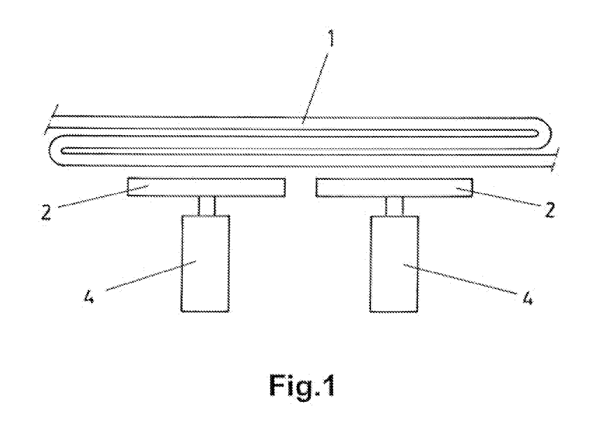

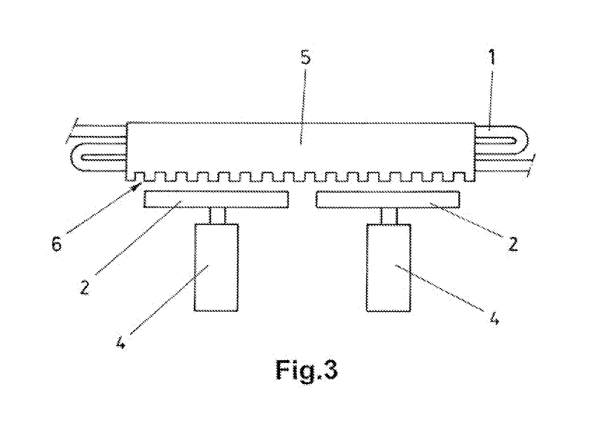

In the practical arrangement, the rotating drive for rotating the discs (2) bearing the magnets (3) can be individually established by means of independent motors (4) actuating different discs (2), such as the solution depicted in FIGS. 1 and 3; but similarly, without this altering the object of the invention, the drive for rotating the discs (2) can be established together by means of a motor (4) coupled to the different discs (2) by means of respective transmissions. The discs (2) bearing the magnets (3) can be rotated using an electric motor or a pneumatic turbine.

The discs (2) bearing the magnets (3) can be two or more in number and arranged in a successive linear distribution or according to any other distribution in which they are consecutively arranged on one and the same plane and such that all the consecutively adjacent discs (2) rotate in opposite directions. The number of magnets (3) incorporated in each disc (2) must in turn be an even number, because the set of magnets (3) on each disc (2) must have alternately opposing polarities.

The system additionally comprises a conventional Peltier cell (not shown in the drawings) for generating electrical energy from the heat generated by the element (1) to be heated once said element (1) has been heated. Alternatively, the system additionally comprises a conventional heat exchanger (not shown in the drawings) for producing cold from the heat generated by the element (1) to be heated once said element (1) has been heated.

According to a practical embodiment, it is envisaged that the element (1) to be heated is covered by an electrically conductive block (5) in the area facing the discs (2) bearing the magnets (3), as seen in FIG. 3, whereby the heat generated by means of magnetic induction of the magnets (3) of the discs (2) accumulates in the block (5), from which it is transmitted to the element (1) housed in the block (5), the heat generated in the system therefore being more efficiently harnessed. In this case, the distance of the magnets (3) incorporated in the discs (2) is established with respect to the mentioned heat-accumulating block (5) which is arranged on the element (1) to be heated.

The heat-accumulating block (5) is further envisaged with a surface provided with a groove (6) facing the discs (2) bearing the magnets (3), which also favors harnessing the magnetic influence for generating heat, in turn improving the functional performance of the system.

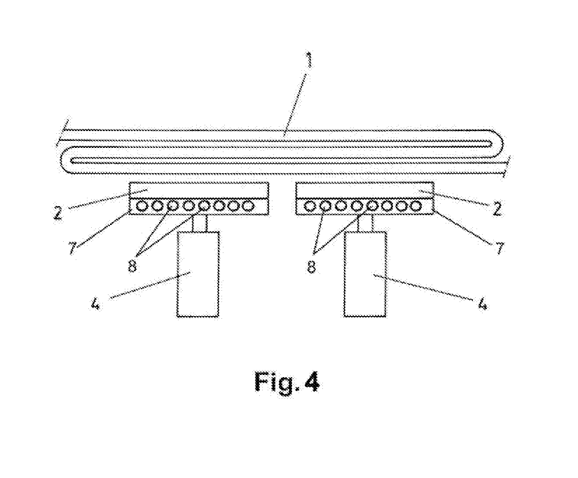

As seen in the embodiment of FIG. 4, each disc (2) which is arranged facing the element (1) to be heated incorporates, coupled to its lower part, an additional disc (7) comprising a set of magnets (8) which are arranged on the outer side contour of the additional disc (7). An additional magnetic influence which causes another drive force is therefore established between the magnets (8) of the additional discs (7) which are arranged consecutively adjacent to one another, so lower power consumption is required for driving the set of discs (2,7).

1. A system for generating heat by means of magnetic induction, comprising a set of magnets which are moved ahead of an electrically conductive element to be heated, wherein two or more discs that are located facing the element to be heated, said discs being arranged consecutively close to one another on one and the same plane, actuated by a rotating drive rotating the consecutively adjacent discs in opposite directions of rotation, each disc incorporating a distribution of magnets having alternately opposing polarities which, upon rotating the discs, produce a magnetic influence for generating heat on the element to be heated and a magnetic influence for driving the rotation between the discs.

2. The system for generating heat by means of magnetic induction according to claim 1, wherein the magnets are arranged in a circular distribution close to the periphery of the respective discs.

3. The system for generating heat by means of magnetic induction according to claim 1, wherein when there are more than two discs, they are located in a distribution allowing rotation of all the consecutively adjacent discs in opposite directions.

4. The system for generating heat by means of magnetic induction according to claim 1, wherein the discs are rotated individually by means of respective independent drive motors.

5. The system for generating heat by means of magnetic induction according to claim 1, wherein the discs are rotated together by means of a drive motor linked to the different discs by means of respective transmissions.

6. The system for generating heat by means of magnetic induction according to claim 1, wherein there is arranged on the element to be heated an electrically conductive block in which heat, generated by the variable magnetic induction of the magnets when the discs rotate, accumulates.

7. The system for generating heat by means of magnetic induction according to claim 6, wherein the block for covering the element to be heated has, facing the discs bearing the magnets, a surface provided with a groove.

8. The system for generating heat by means of magnetic induction according to claim 1, wherein the element to be heated or the block for covering the element to be heated are located at a distance between 2 mm and 4.5 mm with respect to the magnets incorporated in the discs.

9. The system for generating heat by means of magnetic induction according to claim 1, wherein the rotating drive rotating the discs is at least an electric motor.

10. The system for generating heat by means of magnetic induction according to claim 1, wherein the rotating drive rotating the discs is at least a pneumatic turbine.

11. The system for generating heat by means of magnetic induction according to claim 1, wherein it additionally comprises a Peltier cell for generating electrical energy from the heat generated by the element to be heated once the element has been heated.

12. The system for generating heat by means of magnetic induction according to claim 1, wherein it additionally comprises a heat exchanger for producing cold from the heat generated by the element to be heated once the element has been heated.

13. The system for generating heat by means of magnetic induction according to claim 1, wherein each disc facing the element to be heated incorporates, coupled to its lower part, an additional disc comprising a set of magnets which are arranged on the outer side contour of the additional disc.

14. The system for generating heat by means of magnetic induction according to claim 1, wherein the electrically conductive element to be heated is a coil for the circulation of a fluid.
